(19) United States
(12) Patent Application Publication
(10) Pub. No.: US 2011/0203398 A1
(43) Pub. Date: Aug. 25, 2011

(54) Divided Toothed Wheel

(75) Inventor: Alex Meier, Triesen (LI)

(73) Assignee: Thyssenkrupp Presta Teccenter AG, Eschen (LI)

(21) Appl. No.: 13/122,292

(22) PCT Filed: Sep. 7, 2009
(86) PCT No.: PCT/EP2009/006465

§ 371 Date: Apr. 1, 2011

(30) Foreign Application Priority Data
Oct. 4, 2008 (DE) 10 2008 050 471.8

(51) Int. Cl. F16H 55/12; B23P 15/14

(52) U.S. Cl. 74/448; 29/893

(57) ABSTRACT

A divided toothed wheel is provided having two toothed wheel halves in tension in relation to each other, the wheel occupies only a minimum amount of space from the axial direction and the two halves are permanently connected together by a securing element designed as an elastically shapeable annular ring disk. The first toothed wheel half includes a hollow cylindrical collar, to which the second toothed wheel half is secured by the annular ring disk. The annular ring disk includes slots distributed over the periphery and extending radially outwards from a central opening forming spring tongues between the slots. The free ends of the spring tongues have edges that sit on the outer circumference of a component arranged in the central opening, in a form-fitting manner, as the spring tongues spring back after the annular ring disk has pressed against the second toothed wheel half.

### CROSS-REFERENCE TO RELATED APPLICATIONS

This application is related to U.S. patent application Ser. No. ______ (Attorney Docket No. 104029.63355US), entitled “Divided Toothed Wheel”, filed on even date herewith.

### BACKGROUND AND SUMMARY OF THE INVENTION

Exemplary embodiments of the invention relate to a divided toothed wheel having two toothed wheel halves braced against each other, wherein the first toothed wheel half comprises a hollow cylindrical collar, to which the second toothed wheel half is attached by a fastening element.

In the case of shafts driven via a toothed wheel drive, e.g. camshafts or compensating shafts, which in operation rotate at half or double the engine speed, it is known to use a divided toothed wheel having toothed wheel halves braced against each other as the drive element instead of simple one-piece toothed wheels. The play-free bracing of the toothed wheels avoids undesired noise propagation, which could occur, as experience has shown, when using one-piece toothed wheels because some play exists.

EP 0 205 156 B1 discloses a divided toothed wheel which consists of a first toothed wheel part and a second toothed wheel part, wherein the toothed wheel parts are braced against each other via an omega-shaped spring. The first toothed wheel part comprises a hollow cylindrical spigot-shaped collar with which it can be pushed onto a shaft and which surrounds the shaft in the mounted condition. The second toothed wheel part is pushed onto the outer periphery of the collar during mounting. The collar comprises a groove on its outer periphery, into which a snap ring is inserted, with which the second toothed wheel part is attached to the collar in an axially positive locking manner. The second toothed wheel part is supported, with its side surface facing away from the first toothed wheel part, against the snap ring.

In the figures of EP 0 205 156 B1 the snap ring is not shown. The attachment of the second toothed wheel half to the collar is merely described in the descriptive part and not shown in the drawing.

If the snap ring is removed from the groove, the second toothed wheel part can be pulled off the collar. The two toothed wheel parts are thus not connected to each other in a non-releasable manner, but rather the second toothed wheel half is merely held on the collar by a releasable positive locking connection.

A disadvantage with this known connection between the two toothed wheel halves is also that, as seen in the axial direction of the shaft, a large construction space is required because, as seen in the axial direction, the collar of the first toothed wheel half must protrude clearly beyond the side surface of the second toothed wheel half, which faces away from the first toothed wheel half, so that the groove can be produced in the collar and at the same time sufficient “substance” is also still provided at the free end of the collar in order for the collar to have the necessary strength. However, in particular in the case of camshafts or compensating shafts in internal combustion engines, the designers frequently allow only a very small construction space.

A further disadvantage is that a groove has to be produced in the collar of the first toothed wheel half in order for the snap ring to be able to be supported against the collar and thus for axial forces to be able to be absorbed. The groove weakens the strength of the collar (i.e., the so-called “notch effect”) and it is necessary to provide the additional material already referred to above as “substance” at the free end of the collar in order to ensure sufficient strength.

Thus, in view of the known toothed wheel discussed above, exemplary embodiments of the present invention provide a divided toothed wheel having two toothed wheel halves braced against each other, in which, as seen in the axial direction, only a minimum amount of construction space is taken up and the two toothed wheel halves are non-releasably connected to each other.

Exemplary embodiments of the present invention also provide a simple method for assembling a divided toothed wheel having two toothed wheel halves which are braced against each other, wherein, as seen in the axial direction, the two toothed wheel halves can be non-releasably connected to each other in the most space-saving manner possible.

The divided toothed wheel in accordance with the invention comprises two toothed wheel halves which are braced against each other, wherein the first toothed wheel half comprises a hollow cylindrical collar, to which the second toothed wheel half is attached by means of a fastening element. In accordance with the invention the fastening element is formed as an elastically deformable circular ring disk, wherein the circular ring disk comprises slots which extend radially outwards starting from a central opening and are distributed over the periphery so that flexible tongues are formed between the slots, and wherein the free ends of the flexible tongues have edges which are supported in a positive locking manner against the outer periphery of a component disposed in the central opening when the flexible tongues have sprung back after the circular ring disk has been pressed against the second toothed wheel half. During mounting, the circular ring disk is pressed against the second toothed wheel half—which is located on the collar and is braced by means of the first toothed wheel half—in such a manner that the flexible tongues are compressed. Then, the load is removed from the circular ring disk which means that it can resiliently spring back. The edges of the flexible tongues thus penetrate into the material of the component disposed in the central opening so that it is supported against the outer diameter of the component in a positive locking manner.

The two toothed wheel halves are therefore non-releasably connected to each other since they can no longer be separated from one another without destroying the circular ring disk and/or the collar.

The component disposed in the central opening, on whose outer periphery the edges of the flexible tongues are supported in a positive locking manner when the toothed wheel is assembled, can be, for example, a tube or a shaft to which the toothed wheel is attached. It is also possible that the component disposed in the central opening is the collar which the first toothed wheel half comprises. The collar can be a separate component which is connected to the first toothed wheel half. Alternatively, the collar can also be formed in one piece with the first toothed wheel half.

In accordance with the invention the edges of the flexible tongues are formed so as to be blade-shaped. As a result, it is achieved that the edges effectively penetrate into the surface of the component when the flexible tongues spring back and therefore the circular ring disk is effectively supported in a positive locking manner via the flexible tongues on the component.

In order to facilitate the penetration of the edges of the flexible tongues into the material of the component, the edges have a greater hardness than the material of the component in the support region of the edges. In accordance with an exemplary embodiment of the invention, the flexible tongues of the circular ring disk consist of a hardenable metal and at least the edges are hardened so that they have a greater hardness than the material of the component in the support region of the edges.

In order to further reduce the axial extension of the assembled divided toothed wheel, in accordance with an exemplary embodiment of the invention the side surface of the second toothed wheel half facing the circular ring disk comprises a radially extending recess whose border surrounds the circular ring disk. Since this recess has a certain depth in the axial direction, the circular ring disk is at least partly accommodated in this recess and the overall axial extension of the assembled toothed wheel is reduced. Preferably, the depth of the recess in the axial direction is precisely the same size as or is even greater than the axial extension of the circular ring disk itself. In this manner, the circular ring disk does not protrude beyond the axial outer dimensions of the second toothed wheel half and an extremely compact construction is achieved.

A further advantage of the solution in accordance with the invention resides in the fact that a groove does not have to be provided in the component disposed in the central opening of the circular ring disk (i.e., for example in the tube, in the shaft or in the collar of the first toothed wheel half). The fastening means in accordance with the invention effect a positive locking connection with the component by way of the edges of the flexible tongues penetrating into the material of the component without a groove being required to support the fastening element, which groove would weaken the strength of the component. It is also not necessary to form the component with an axial “excess length” in order to provide sufficient strength for the component. In this manner, the effective axial extension of the component can be reduced and therefore the construction space required in the axial direction for the assembled divided toothed wheel can be minimized.

In the case of the method in accordance with the invention for assembling a divided toothed wheel having two toothed wheel halves braced against each other, a first toothed wheel half comprising a hollow cylindrical collar is used as the starting point. A second toothed wheel half is pushed onto the collar, wherein the second toothed wheel half is attached to the collar by a fastening element.

The method in accordance with the invention includes the following method steps: an elastically deformable circular ring disk is used as the fastening element and comprises slots which extend radially outwards starting from a central opening and are distributed over the periphery so that flexible tongues are formed between the slots, wherein the free ends of the flexible tongues have edges which are supported in a positive locking manner against the outer periphery of a component disposed in the central opening of the circular ring disk when the flexible tongues have sprung back after the circular ring disk has been pressed against the second toothed wheel half.

When assembling the divided toothed wheel, firstly the second toothed wheel half is pushed onto the collar of the first toothed wheel half. Then, the circular ring disk is pushed onto the component disposed in the central opening of the circular ring disk and is pressed against the second toothed wheel half, compressing the flexible tongues. The load is then removed from the circular ring disk, wherein the flexible tongues spring back and are supported, by means of their edges, in a positive locking manner against the outer periphery of the component.

With the method in accordance with the invention a non-releasable connection between the two toothed wheel halves can easily be produced and only minimum construction space is required in the axial direction. Assembled two-part toothed wheels can therefore be produced, having a clearly smaller axial extension than the known toothed wheels discussed above. In particular, when used in internal combustion engines, e.g. on camshafts or compensating shafts, construction space can be saved in this manner or available construction space can be optimally exploited.

In order to produce the circular ring disk in accordance with the invention a band-shaped semi-finished product consisting of hardenable spring steel is used as the starting point. First, a metal sheet is separated from the band. Then, a metal sheet blank is punched free and subsequently pot drawing of the metal sheet blank is effected. Following therefrom, the slots disposed in a star-shaped manner are stamped and the subsequent flexible tongues are shaped by bending the “star”. Then, the central opening is produced by way of a punching out procedure and the flexible tongues obtain their blade-shaped edges. The individual processing steps can expediently be effected in a progressive die. Finally, the circular ring disk is subjected to heat treatment in which at least the flexible tongues are hardened at their free ends in the region of the edges.

### BRIEF DESCRIPTION OF THE DRAWING FIGURES

The invention will be described in more detail hereinafter with the aid of a drawing in which, in detail:

FIG. 1 shows an exploded view of the divided toothed wheel in accordance with the invention,

FIG. 2 shows a radial half-cross-sectional view of the divided toothed wheel in accordance with the invention in the assembled condition on a shaft end, and

FIG. 3 shows a perspective view of the divided toothed wheel mounted on an end of a camshaft.

### DETAILED DESCRIPTION

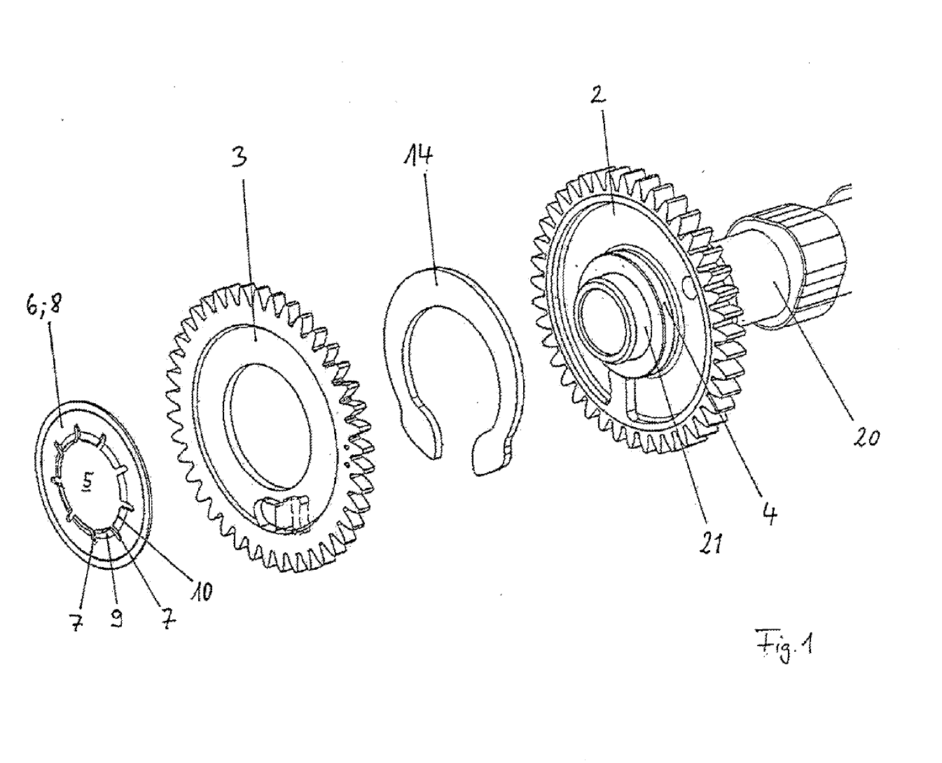

The exploded view in FIG. 1 shows a first toothed wheel half 2 which is attached to the shaft end 21 of a camshaft 20. The first toothed wheel half 2 comprises a collar 4 extending in the axial direction. In order to assemble the toothed wheel, the second toothed wheel half 3 is pushed onto the collar 4 in the axial direction. A spring element 14 is disposed between the two toothed wheel halves and is supported on the one hand against the first toothed wheel half 2 and on the other hand against the second toothed wheel half 3 when mounted. This spring element 14 ensures that the two toothed wheel halves are braced against each other in the mounted condition in a known manner.

If the second toothed wheel half 3 is pushed onto the collar 4, the two toothed wheel halves 2, 3 are attached to the shaft end 21 of the camshaft 20. Of course, the first toothed wheel half 2 could first be attached to the shaft end 21 and then the second toothed wheel half 3 could be mounted with the spring element 14. In accordance with the invention, the circular ring disk 8 is used as the fastening element 6 and is pushed onto the shaft end 21 of the camshaft 20. The circular ring disk 8 has a central opening 5, allowing it to be pushed onto the end of the camshaft 20. Slots 7 extend radially outwards starting from the central opening 5 and are distributed over the periphery. Lug-like flexible tongues 9 are formed between these slots 7 and have edges 10 at their free ends.

In order to assemble the divided toothed wheel in accordance with the invention and to connect the two toothed wheel halves 2, 3 together in a permanent and non-releasable manner, the circular ring disk 8 is pressed against the second toothed wheel half 3 such that the flexible tongues 9 are compressed. The load is then removed from the circular ring disk 8 causing the flexible tongues 9 to spring back. During this springing back movement, the edges 10 of the flexible tongues 9 penetrate into the material of the tubular body of the shaft end 21 of the hollow cylindrical camshaft 20 which means that an abutment is formed on the outer periphery of the shaft end 21, wherein the edges 10 of the flexible tongues 9 are supported against this abutment.

It is now no longer possible to separate the two toothed wheel halves 2, 3 from each other without destroying or damaging the circular ring disk 8 and/or the camshaft 20. There therefore exists a non-releasable connection between the two toothed wheel halves 2, 3 which is produced by the circular ring disk 8.

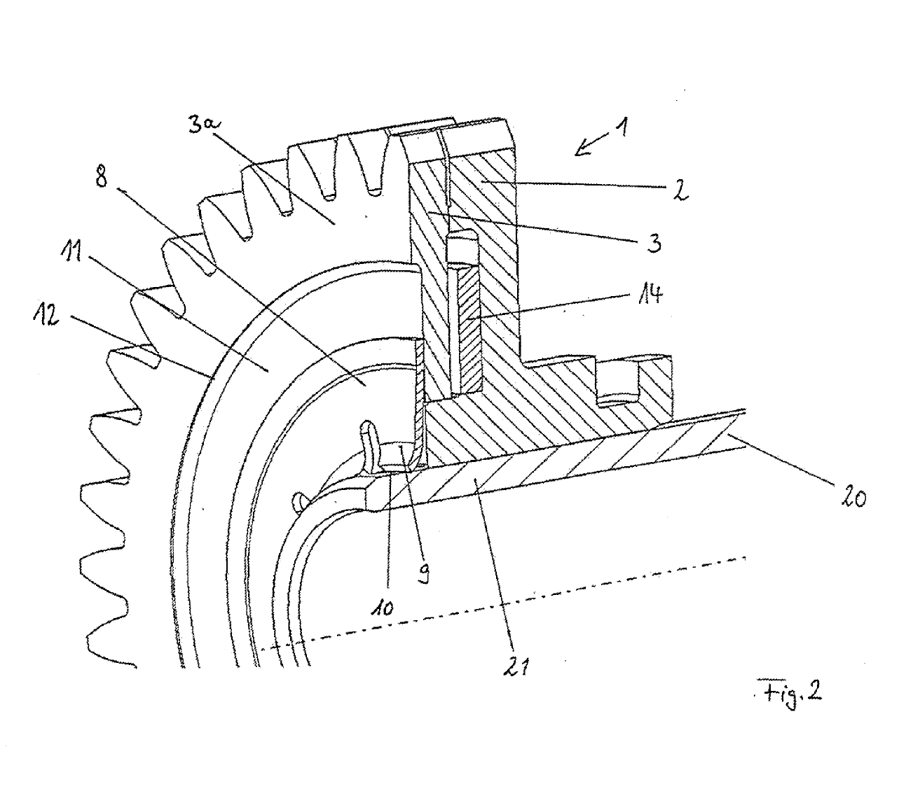

FIG. 2 illustrates a radial half-cross-sectional view of the divided toothed wheel 1 in accordance with the invention in the assembled condition on the shaft end 21 of the camshaft 20. The circular ring disk 8 is supported, by the blade-shaped edges 10 of its flexible tongues 9, in a positive locking manner on the outer surface of the shaft end 21 of the camshaft 20. The side surface 3a of the second toothed wheel half 3 facing the circular ring disk 8 comprises a radially extending recess 11 whose border 12 surrounds the circular ring disk 8. The depth of the recess 11 in the axial direction is precisely the same size as or is greater than the axial extension of the circular ring disk 8. As a result, the circular ring disk 8 does not protrude axially beyond the dimensions of the second toothed wheel half 3. The recess 11 can be produced in the second toothed wheel half e.g., by a cutting machining process such as lathing or milling. If the second toothed wheel is produced e.g., by forging, then the recess can also be produced using forging technology.

In order for the edges 10 of the flexible tongues 9, formed so as to be blade-shaped, to be able to be effectively incorporated in the material of the camshaft 20 when the flexible tongues 9 have sprung back, the edges 10 have a greater hardness than the material of which the tubular body of the camshaft 20 consists in the support region of the edges 10. The blade-shaped edges 10 can thus be effectively incorporated in the surface of the camshaft 20 owing to their hardness and sharpness, when the load is removed from the circular ring disk 8 after being pressed against the second toothed wheel half 3 during assembly of the toothed wheel, and when the flexible tongues 9 spring back.

In the illustrated exemplified embodiment, the circular ring disk 8 consists of a hardenable metal. The free ends of the flexible tongues 9 are hardened in order to achieve the required hardness for the blade-shaped edges 10.

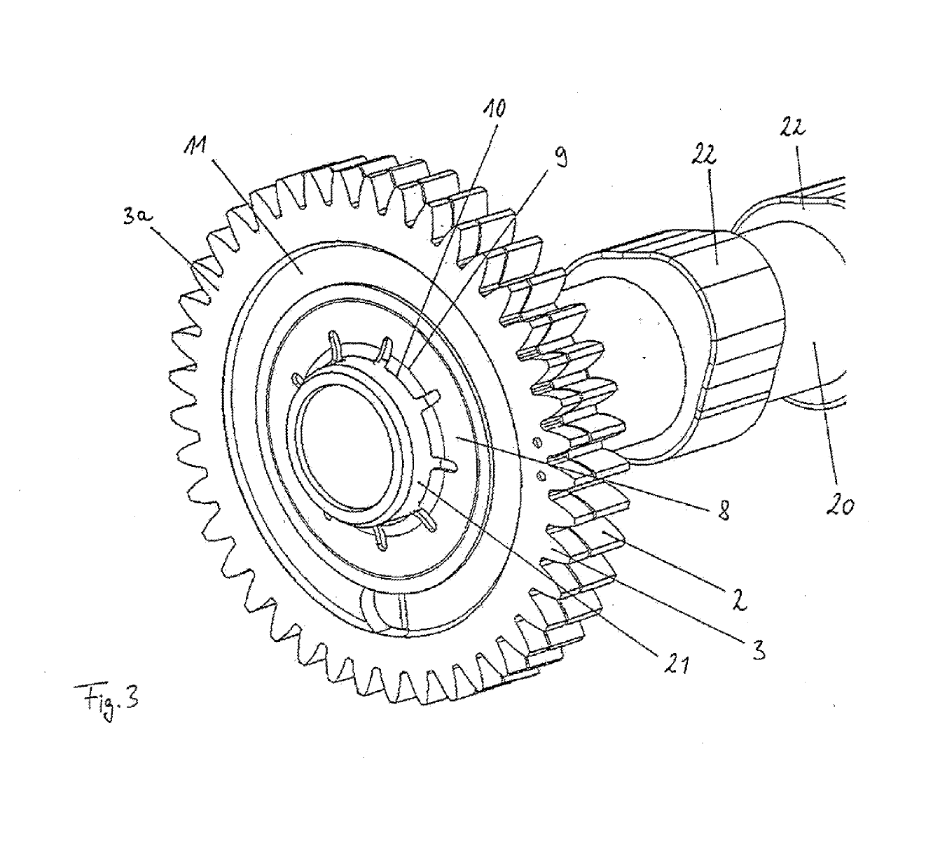

In the perspective view in accordance with FIG. 3, the divided toothed wheel 1 in accordance with the invention is disposed in the assembled condition on the shaft end 21 of a camshaft 20 bearing a cam 22. The second toothed wheel half 3 is located on the collar of the first toothed wheel half 2, which collar cannot be seen in FIG. 3. The toothed wheel halves 2, 3 are braced against each other by a spring element disposed between the halves and is not illustrated. The circular ring disk 8 is supported on the outer periphery of the shaft end 21 in a positive locking manner with the edges 10 of the flexible tongues 9. The second toothed wheel half 3 is fixed in this manner to the collar of the first toothed wheel half 2 in an axially positive locking manner. The circular ring disk 8 is accommodated in the recess 11 of the second toothed wheel half 3. It can clearly be seen that the shaft end 21 only protrudes to an extremely small extent in the axial direction beyond the side surface 3a of the second toothed wheel half 3, which achieves a construction that is extremely compact in the axial direction. If the thickness of the second toothed wheel half 3 is sufficiently large then the depth of the recess 11 can be configured to be so large that the shaft end 21 terminates flush with the side surface 3a of the second toothed wheel half 3. In this manner, the shaft end 21 does not take up any axial construction space beyond the dimensions of the divided toothed wheel.

FIGS. 1 to 3 illustrate an embodiment of the invention in which the edges 10 of the flexible tongues 9 are supported in a positive locking manner on the outer periphery of a tubular hollow cylindrical shaft body of a camshaft 20. Of course, the invention can also equally be used in the case of solid shaft bodies. In accordance with another embodiment of the invention not illustrated in FIGS. 1 to 3, the edges 10 of the flexible tongues 9 can also be supported in a positive locking manner on the collar 4 of the first toothed wheel half 2. In this case, the collar 4 has a larger axial extension than is required for accommodating the second toothed wheel half 3. The protruding section of the collar 4 can then be used as a support surface for the edges 10 of the flexible tongues. In this case it is advantageous if the divided toothed wheel can already be completely assembled before it is mounted e.g., on a camshaft 20.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Toothed wheel
2 Toothed wheel half
3 Toothed wheel half
3a Side surface
4 Collar
5 Opening
6 Fastening element
7 Slot
8 Circular ring disk
9 Flexible tongue
10 Edge
11 Recess
12 Border
14 Spring element
20 Camshaft
21 Shaft end
22 Cam
B Component
R Tube
W Shaft

1-10. (canceled)

11. A divided toothed wheel, comprising:
a first toothed wheel half; and
a second toothed wheel half, the first and second toothed wheel halves being braced against each other,
wherein the first toothed wheel half comprises a hollow cylindrical collar, to which the second toothed wheel half is attached by a fastening element, wherein the fastening element is an elastically deformable circular ring disk, wherein the circular ring disk comprises slots extending radially outwards starting from a central opening and are distributed over a periphery so that flexible tongues are formed between the slots, and wherein free ends of the flexible tongues have edges supported in a positive locking manner against an outer periphery of a component disposed in the central opening when the flexible tongues have sprung back after the circular ring disk is pressed against the second toothed wheel half.

12. The toothed wheel as claimed in claim 11, wherein the component is a tube or a shaft to which the toothed wheel is attached.

13. The toothed wheel as claimed in claim 11, wherein the component is the hollow cylindrical collar of the first toothed wheel half.

14. The toothed wheel as claimed in claim 13, wherein the hollow cylindrical collar is attached to the first toothed wheel half or is an integral piece of the first toothed wheel half.

15. The toothed wheel as claimed in claim 10, wherein the edges of the flexible tongues are blade-shaped.

16. The toothed wheel as claimed in claim 11, wherein the edges of the flexible tongues have a greater hardness in a support region of the edges than a material of the component.

17. The toothed wheel as claimed in claim 16, wherein at least the flexible tongues consist of a hardenable metal and at least the edges are hardened.

18. The toothed wheel as claimed in claim 11, wherein a side surface of the second toothed wheel half facing the circular ring disk comprises a radially extending recess with border surrounding the circular ring disk.

19. The toothed wheel as claimed in claim 18, wherein a depth of the recess in an axial direction is precisely a same size as or is greater than an axial extension of the circular ring disk.

20. A method for assembling a divided toothed wheel with a first toothed wheel half and a second toothed wheel half, the first and second toothed wheel halves being braced against each other, wherein the first toothed wheel half comprises a hollow cylindrical collar and the second toothed wheel half is pushed onto the collar, wherein the second toothed wheel half is attached to the collar a fastening element, the method comprising:
a) using an elastically deformable circular ring disk is as the fastening element, the elastically deformable circular ring disk comprising slots extending radially outwards starting from a central opening and are distributed over the periphery so that flexible tongues are formed between the slots, wherein a free ends of the flexible tongues have edges supported in a positive locking manner against an outer periphery of a component disposed in the central opening when the flexible tongues have sprung back after the circular ring disk has been pressed against the second toothed wheel half;
b) firstly, pushing the second toothed wheel half is onto the collar of the first toothed wheel half;
c) secondly, pushing the circular ring disk onto the component and against the second toothed wheel half, compressing the flexible tongues;
d) thirdly, removing the load from the circular ring disk, wherein the flexible tongues spring back and are supported, by their edges, in a positive locking manner against the outer periphery of the component.
